(19) United States
(12) Patent Application Publication
(10) Pub. No.: US 2026/0203958 A1
(43) Pub. Date: Jul. 16, 2026

(54) LIVE STREAMING SPECIAL EFFECT RENDERING METHOD AND APPARATUS, DEVICE, READABLE STORAGE MEDIUM, AND PRODUCT

(71) Applicant: Beijing Zitiao Network Technology Co., Ltd., Beijing (CN)

(72) Inventor: Yi ZHANG, Beijing (CN)

(21) Appl. No.: 18/867,727

(22) PCT Filed: Aug. 29, 2023
(86) PCT No.: PCT/CN2023/115616

§ 371 Date: Nov. 20, 2024

(30) Foreign Application Priority Data
Sep. 6, 2022 (CN) 202211086338.4

(51) Int. Cl. G06T 11/00; G06T 3/40

(52) U.S. Cl. CPC G06T 11/00; G06T 3/40; G06T 2210/22; G06T 2210/32; G06T 2210/36

(57) ABSTRACT

Embodiments of the present disclosure provide a live streaming special effect rendering method and apparatus, an electronic device, a computer-readable storage medium, a computer program product, and a computer program. The method includes: acquiring a live streaming image frame corresponding to virtual reality live streaming content and a preset target special effect; determining key point information corresponding to at least part of target objects in the live streaming image frame; performing, according to the target special effect and the key point information, a special effect rendering operation on the live streaming image frame, to obtain a target image frame; and displaying the target image frame.

### CROSS-REFERENCE TO RELATED APPLICATION

This application is a national stage of International Application No. PCT/CN2023/115616, filed on Aug. 29, 2023, which claims priority to Chinese Patent Application No. 202211086338.4, filed on Sep. 6, 2022. Both of the aforementioned applications are hereby incorporated by reference in their entireties.

### TECHNICAL FIELD

Embodiments of the present disclosure relate to the technical field of image processing, and in particular, to a live streaming special effect rendering method and apparatus, an electronic device, a computer-readable storage medium, a computer program product, and a computer program.

### BACKGROUND

Virtual Reality (VR) panoramic live streaming is usually performed by using a binocular camera to perform real-time shooting. VR live streaming usually uses an 8K or higher video frame (7680*4320), and compared with a traditional 2K (2048*unspecified value) or 720P (1280*720) video frame, the video frame belongs to an ultra-high-definition video frame. Due to a requirement for a time delay during a live streaming process, the time actually available for special effect rendering is relatively short. Therefore, it is required to complete an algorithm and rendering of a special effect for an 8K image within a limited time to ensure a good experience of the VR live streaming. How to ensure fast special effect rendering during a VR live streaming process becomes a technical problem to be solved urgently.

### SUMMARY

The embodiments of the present disclosure provide a live streaming special effect rendering method and apparatus, an electronic device, a computer-readable storage medium, a computer program product, and a computer program, to solve technical problems that a special effect rendering speed of collected ultra-high-definition video frames is slow in a VR live streaming scenario, and a live streaming effect cannot be ensured.

In a first aspect, an embodiment of the present disclosure provides a live streaming special effect rendering method, including:
acquiring a live streaming image frame corresponding to virtual reality live streaming content and a preset target special effect;
determining key point information corresponding to at least part of target objects in the live streaming image frame;
performing, according to the target special effect and the key point information, a special effect rendering operation on the live streaming image frame, to obtain a target image frame; and
displaying the target image frame.

In a second aspect, an embodiment of the present disclosure provides a live streaming special effect rendering apparatus, including:
an acquiring module, configured to acquire a live streaming image frame corresponding to virtual reality live streaming content and a preset target special effect;
a determining module, configured to determine key point information corresponding to at least part of target objects in the live streaming image frame;
a rendering module, configured to perform, according to the target special effect and the key point information, a special effect rendering operation on the live streaming image frame, to obtain a target image frame; and
a display module, configured to display the target image frame.

In a third aspect, an embodiment of the present disclosure provides an electronic device, including: a processor and a memory;
where the memory stores a computer-executable instruction; and
the processor executes the computer-executable instruction stored in the memory, to enable the processor to perform the live streaming special effect rendering method according to the first aspect and various possible designs of the first aspect.

In a fourth aspect, an embodiment of the present disclosure provides a computer-readable storage medium, where the computer-readable storage medium stores a computer-executable instruction that, when executed by a processor, implements the live streaming special effect rendering method according to the first aspect and various possible designs of the first aspect.

In a fifth aspect, an embodiment of the present disclosure provides a computer program product, including a computer program that, when executed by a processor, implements the live streaming special effect rendering method according to the first aspect and various possible designs of the first aspect.

In a sixth aspect, an embodiment of the present disclosure provides a computer program that, when executed by a processor, implements the live streaming special effect rendering method according to the first aspect and various possible designs of the first aspect.

### BRIEF DESCRIPTION OF DRAWINGS

In order to more clearly describe technical solutions in the embodiments of the present disclosure or the related art, the following briefly describes drawings required for describing the embodiments or the related art. Apparently, the drawings in the following description show some embodiments of the present disclosure, and a person of ordinary skill in the art may still derive other drawings from these drawings without creative efforts.

FIG. 1 is a diagram of a system architecture on which the present disclosure is based.

FIG. 2 is a flow diagram of a live streaming special effect rendering method provided by an embodiment of the present disclosure.

FIG. 3 is an expansion diagram provided by an embodiment of the present disclosure.

FIG. 4 is a flow diagram of a live streaming special effect rendering method provided by another embodiment of the present disclosure.

FIG. 5 is a diagram of an application scenario provided by an embodiment of the present disclosure.

FIG. 6 is a flow diagram of a live streaming special effect rendering method provided by yet another embodiment of the present disclosure.

FIG. 7 is a structural diagram of a live streaming special effect rendering apparatus provided by an embodiment of the present disclosure.

FIG. 8 is a structural diagram of an electronic device provided by an embodiment of the present disclosure.

### DESCRIPTION OF EMBODIMENTS

To make objectives, the technical solutions, and advantages of the embodiments in the present disclosure clearer, the following clearly and completely describes the technical solutions in embodiments of the present disclosure with reference to the drawings in embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

To solve the technical problems that a special effect rendering speed of collected ultra-high-definition video frames in a VR live streaming scenario is slow and a live streaming effect cannot be ensured, the present disclosure provides a live streaming special effect rendering method and apparatus, a device, a readable storage medium, and a product.

It should be noted that the live streaming special effect rendering method and apparatus, the device, the readable storage medium, and the product provided in the present disclosure may be applied to any image rendering scenario in a VR scenario.

Existing VR panoramic live streaming uses a binocular camera to perform real-time shooting. Usually, an 8K (7680*4320 ) or higher video frame is used, and compared with a traditional 2K (2048 *unspecified value) or 720P (1280*720) video frame, the video frame belongs to an ultra-high-definition video frame. An amount of data of a single 8K frame is 7680*4320*4 Byte=126 MB. A live streaming frame rate is generally required to be 30 to 60 fps. An upper limit of a time delay of a single frame is 16 ms to 33 ms, and an actual time window available for special effect rendering may be even shorter. It is required to complete an algorithm and special effect rendering for an 8K image within a limited time to ensure a good experience of the VR live streaming.

In a process of solving the foregoing technical problems, the inventors have found through research that, to improve a special effect rendering speed and ensure a good experience of VR live streaming, a graphics processor may be used to perform a special effect rendering operation, and a central processor may be used to perform identification and detection operations. To further improve the special effect rendering speed, a range of special effect rendering may be concentrated at a streamer or around the streamer, so that a pixel region that actually needs to be processed can be narrowed. In addition, because an amount of data of a live streaming image frame is large, it is necessary to avoid time consumption of data transmission between a central processing unit (CPU) and a graphics processing unit (GPU). Therefore, before a live streaming image frame acquired by a graphics processor is sent to a central processor, a compression operation and/or a cropping operation may be performed on the live streaming image frame to reduce an amount of transmitted data and improve a transmission speed.

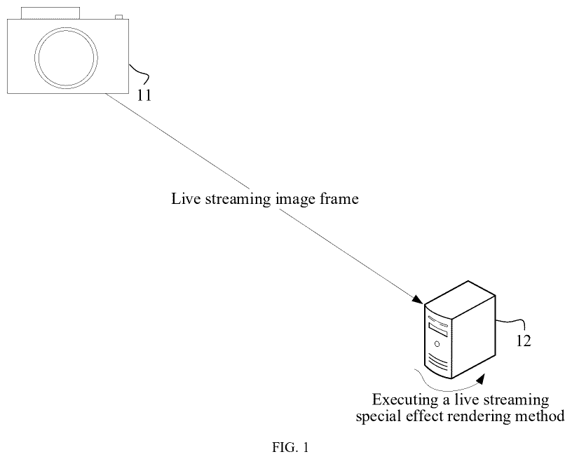

FIG. 1 is a diagram of a system architecture on which the present disclosure is based. As shown in FIG. 1, the system architecture on which the present disclosure is based at least includes: a binocular image collection apparatus 11 and a server 12, where a graphics processor and a central processor are respectively provided in the server 12, and a live streaming special effect rendering apparatus is provided in the graphics processor and the central processor. The live streaming special effect rendering apparatus may be written in a language such as C/C++, Java, Shell, or Python, etc.

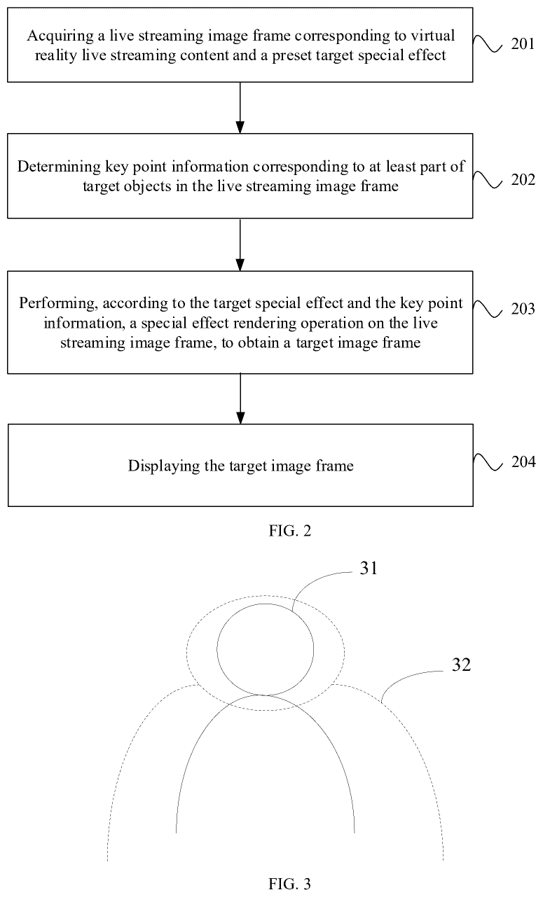

FIG. 2 is a flow diagram of a live streaming special effect rendering method according to an embodiment of the present disclosure. As shown in FIG. 2, the method includes following steps.

Step 201: acquiring a live streaming image frame corresponding to virtual reality live streaming content and a preset target special effect.

An execution subject of the present embodiment is a live streaming special effect rendering apparatus. The live streaming special effect rendering apparatus may be coupled to a server, and a graphics processor and a central processor are respectively provided in the server.

In this implementation, when a user performs virtual reality (VR) live streaming, the user may select content such as a special effect, beauty retouching, and a filter according to an actual requirement, to improve a live streaming effect. After a target special effect selected by the user is acquired, a special effect rendering operation needs to be performed on live streaming content according to the target special effect, to achieve an adornment effect.

In VR live streaming, to ensure a live streaming effect, a binocular image collection apparatus is used to perform a collection operation for live streaming content. A live streaming image frame collected by the binocular image collection apparatus is usually an 8K (7680*4320 ) or higher image frame and has a large size, and a special effect rendering process takes a long time.

Accordingly, to implement a special effect rendering operation on the live streaming content, the live streaming special effect rendering apparatus may acquire the live streaming image frame corresponding to the virtual reality live streaming content. The live streaming image frame may be collected at a preset time interval, or may be collected at a preset frequency, which is not limited in the present disclosure. The live streaming image frame may specifically be collected by the binocular image collection apparatus, or may be collected by other image collection apparatuses that can support virtual reality live streaming content collection, which is not limited in the present disclosure.

Accordingly, to implement the special effect rendering operation on the live streaming image frame, the preset target special effect may further be acquired. The target special effect may be selected by a user according to an actual requirement during a live streaming process.

Step 202: Determining key point information corresponding to at least part of target objects in the live streaming image frame.

In this implementation, to improve a special effect rendering speed and avoid a freeze during the live streaming process, the special effect rendering operation may be concentrated around the at least part of the target objects in the live streaming image frame. The target objects may be a person, an animal, a specific object, etc., in the live streaming image frame.

Therefore, after the live streaming image frame is acquired, the key point information corresponding to the at least part of the target objects in the live streaming image frame may be determined. In an embodiment, the key point information corresponding to the at least part of the target objects in the live streaming image frame may be determined according to a preset detection algorithm. The key point information may specifically be coordinate information of a key position in the target objects.

Step 203: Performing, according to the target special effect and the key point information, a special effect rendering operation on the live streaming image frame, to obtain a target image frame.

In this implementation, after the key point information is acquired, the special effect rendering operation may be performed on the live streaming image frame by using the target special effect and according to the key point information, to obtain the target image frame. Therefore, it is not necessary to perform a special effect rendering on all positions of the live streaming image frame, and efficiency of the special effect rendering is improved while a display effect of the target objects is optimized.

Step 204: Displaying the target image frame.

In this implementation, after the special effect rendering operation on the live streaming image frame is completed to obtain the target image frame, the target image frame may be displayed.

In an embodiment, the target image frame is distributed to a preset terminal device for display. The preset terminal device may be at least part of virtual reality devices that watch VR live streaming, so that the user watches the virtual reality live streaming through the virtual display device.

Alternatively, if the live streaming special effect rendering apparatus is coupled to a terminal device, the terminal device may be directly controlled to display the target image frame on a preset display interface.

It should be noted that since the graphics processor and the central processor are respectively provided in the server, the graphics processor may be used to perform the special effect rendering operation, and the central processor may be used to perform key point identification. Alternatively, the central processor may be used to perform the special effect rendering operation, and the graphics processor may be used to perform the key point identification, which is not limited in the present disclosure.

In the live streaming special effect rendering method provided in the present embodiment, after the live streaming image frame corresponding to the virtual reality live streaming content is acquired, the key point information in the live streaming image frame is determined, and the special effect rendering operation is performed on a position in the live streaming image frame that is associated with the key point information according to the key point information. Therefore, a region for the special effect processing can be concentrated at the position associated with the key point information, so that the region where the special effect needs to be performed is effectively narrowed, and efficiency of special effect processing can be improved.

In actual application, different target special effects may correspond to different display effects, and accordingly have different rendering positions. For example, a rendering position corresponding to a special effect such as beauty retouching, a sticker for a face, or an adornment for a head, etc., may be a face or the head. A rendering position corresponding to a special effect such as a filter or a global display special effect is the entire live streaming image frame. Therefore, different target special effects may be rendered in different rendering manners.

In an embodiment, on the basis of any one of the foregoing embodiments, step 203 includes:
determining, according to the key point information corresponding to the at least part of the target objects, a target region where the at least part of the target objects is located in the live streaming image frame;
if the target special effect is a special effect applied to a local region, for at least part of the target region, performing, according to the target special effect, a local rendering operation on the target region, to obtain a rendering result of the target region; and
for the at least part of the target region, covering the live streaming image frame with the rendering result of the target region, to obtain the target image frame.

In the present embodiment, the target special effect may specifically be a special effect applied to a local region. For example, the target special effect may be a beauty retouching special effect, and the beauty retouching special effect is a special effect applied only to a face. Alternatively, the target special effect may be a headwear special effect, and the headwear special effect may be a special effect applied only to a head. Therefore, for the foregoing special effect applied to the local region, a special effect rendering operation may be performed only on the target region, and no special effect rendering operation is performed on other positions in the live streaming image frame. Therefore, a region where special effect processing is performed can be concentrated at the position associated with the key point information, so that a range of special effect rendering is effectively reduced, and a speed of the special effect rendering is improved.

Specifically, when the target special effect is a special effect applied to a local region, a local rendering operation may be performed on each target region according to the target special effect, to obtain the rendering result of the target region. After the special effect rendering is completed, the live streaming image frame may be covered with the rendering result of the target region, to obtain the target image frame.

Further, on the basis of any one of the foregoing embodiments, the performing, according to the target special effect, a local rendering operation on the target region includes:
if it is detected that the target special effect meets a preset expansion condition, performing, based on a preset region expansion algorithm, an expansion operation on the target region, to obtain a region to be rendered; and
performing, according to the target special effect, the local rendering operation on the region to be rendered.

In the present embodiment, to ensure a rendering effect of an edge of the target region, the expansion operation may be performed on the target region. Specifically, if it is detected that the target special effect meets the preset expansion condition, the expansion operation is performed on the target region based on the preset region expansion algorithm, to obtain the region to be rendered. The preset expansion condition may be that when the target special effect is a special effect applied to a face or other preset positions, the expansion operation may be performed. The local rendering operation is performed on the expanded region to be rendered according to the target special effect.

FIG. 3 is an expansion diagram provided by an embodiment of the present disclosure. As shown in FIG. 3, to obtain a better rendering effect, after a target region 31 is acquired, an expansion operation may be performed on the target region 31 to obtain a to-be-rendered region 32.

In the live streaming special effect rendering method provided in the present embodiment, the expansion operation is performed on the target region when the target special effect meets the preset expansion condition, so that a rendering effect of a special effect can be ensured, and live streaming quality is improved.

In an embodiment, on the basis of any one of the foregoing embodiments, step 203 includes:
if the target special effect is a special effect applied to a global region, performing, according to the target special effect, the special effect rendering operation on the live streaming image frame, to obtain the target image frame.

In the present embodiment, the target special effect may further include a special effect applied to a global region, for example, a filter, raindrops displayed globally, etc. Therefore, when the target special effect is a special effect applied to a global region, the special effect rendering operation may be performed on the live streaming image frame according to the target special effect to obtain the target image frame.

In the live streaming special effect rendering method provided in the present embodiment, the special effect rendering operation is performed on the position associated with the key point information in the live streaming image frame according to the key point information. Therefore, a region where the special effect processing is performed can be concentrated at the position associated with the key point information, so that the region where the special effect processing needs to be performed is effectively narrowed, and the efficiency of the special effect processing can be improved.

It should be noted that since the graphics processor and the central processor are respectively provided in the server, the central processor may be used to perform the key point identification operation, and the graphics processor may be used to perform the special effect rendering according to the key point information according to processing features of different processors.

Further, on the basis of any one of the foregoing embodiments, step 202 includes:
determining, by a preset central processor, the key point information corresponding to the at least part of the target objects in the live streaming image frame; and
step 203 includes:
performing, by a preset graphics processor, the special effect rendering operation on the live streaming image frame according to the target special effect and the key point information to obtain the target image frame.

In the present embodiment, the graphics processor is in communication connection with the central processor and the binocular image collection apparatus respectively, so that the live streaming image frame collected by the binocular image collection apparatus is acquired, a detection operation is performed by the central processor, and the special effect rendering operation is performed by the graphics processor.

Therefore, after the live streaming image frame is acquired, the graphics processor may send the live streaming image frame to the central processor. Correspondingly, after the live streaming image frame is acquired, the central processor determines, according to the preset detection algorithm, the key point information corresponding to the at least part of the target objects in the live streaming image frame. The key point information may specifically be coordinate information of a key position in the target objects. The central processor then feeds back the key point information to the graphics processor.

After the key point information is acquired, the graphics processor may perform a rendering operation on the live streaming image frame by using a rendering manner corresponding to the target special effect and according to the key point information.

In the live streaming special effect rendering method provided in the present embodiment, after the live streaming image frame corresponding to the virtual reality live streaming content is acquired, the central processor is used to calculate the key point information in the live streaming image frame, and the graphics processor is used to perform the special effect rendering operation on the position associated with the key point information in the live streaming image frame according to the key point information. Therefore, the region where the special effect processing is performed can be concentrated at the position associated with the key point information, so that the region where the special effect processing needs to be performed is effectively narrowed, and the efficiency of the special effect processing can be improved. In addition, the graphics processor is used to perform the special effect processing operation, so that a transmission of a large amount of live streaming image frames can be effectively avoided, time consumption of data transmission is reduced, and the efficiency of the special effect processing can be further improved.

Further, on the basis of any one of the foregoing embodiments, step 202 includes:
performing a size adjustment operation on the live streaming image frame to obtain an adjusted live streaming image frame; and
determining, by the central processor, the key point information corresponding to the at least part of the target objects in the adjusted live streaming image frame.

In the present embodiment, the live streaming image frame is generally an 8K (7680*4320 ) or higher image frame, and has a relatively large size. Therefore, a key point identification operation based on the live streaming image frame takes a long time. To ensure the live streaming effect, before an identification of the key point information of the live streaming image frame, a size adjustment operation may be performed on the live streaming image frame to obtain the adjusted live streaming image frame. The size adjustment operation may be a size scaling operation on the live streaming image frame, which scales the live streaming image frame to a 1K image frame, so that key point identification efficiency based on the adjusted live streaming image frame is relatively high.

Further, since the graphics processor and the central processor are respectively provided in the server, the central processor may be used to perform the identification of the key point information. In addition, the graphics processor may acquire the live streaming image frame, or the central processor may acquire the live streaming image frame, or a user may perform setting according to an actual requirement. In the present embodiment, an execution subject for acquiring the live streaming image frame is not limited.

Therefore, after a size adjustment of the live streaming image frame is completed and the adjusted live streaming image frame is obtained, the central processor may determine the key point information corresponding to the at least part of the target objects in the adjusted live streaming image frame.

In the live streaming special effect rendering method provided in the present embodiment, after the live streaming image frame corresponding to the virtual reality live streaming content is acquired, the size adjustment of the live streaming image frame is performed, and the central processor is used to calculate the key point information in the live streaming image frame, so that a calculation amount in a key point identification process can be effectively reduced, and the rendering efficiency of the live streaming image frame is improved. Therefore, virtual reality live streaming can be ensured to be smooth without freezes, and a user experience is improved.

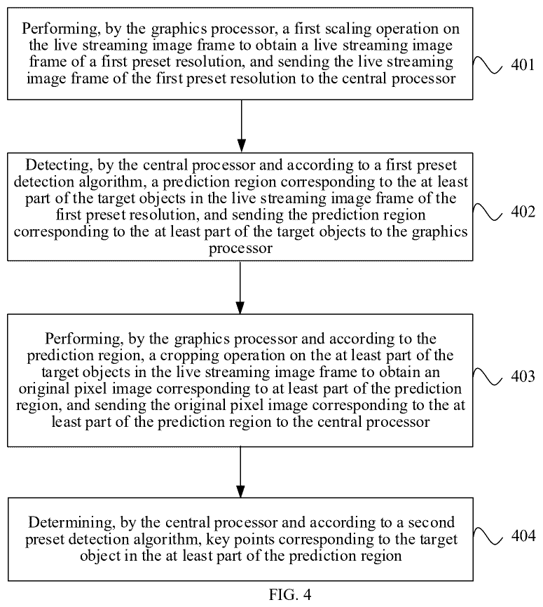

FIG. 4 is a flow diagram of a live streaming special effect rendering method provided by another embodiment of the present disclosure. On the basis of any one of the foregoing embodiments, as shown in FIG. 4, step 202 includes following steps.

Step 401: performing, by the graphics processor, a first scaling operation on the live streaming image frame to obtain a live streaming image frame of a first preset resolution, and sending the live streaming image frame of the first preset resolution to the central processor.

Step 402: detecting, by the central processor and according to a first preset detection algorithm, a prediction region corresponding to the at least part of the target objects in the live streaming image frame of the first preset resolution, and sending the prediction region corresponding to the at least part of the target objects to the graphics processor.

Step 403: performing, by the graphics processor and according to the prediction region, a cropping operation on the at least part of the target objects in the live streaming image frame to obtain an original pixel image corresponding to at least part of the prediction region, and sending the original pixel image corresponding to the at least part of the prediction region to the central processor.

Step 404: determining, by the central processor and according to a second preset detection algorithm, key points corresponding to the target object in the at least part of the prediction region.

In the present embodiment, since pixel values of the live streaming image frame are generally (7680*4320) or higher, an amount of data of a single frame is 7680*4320*4 Byte=126 MB, and therefore, a transmission duration of the live streaming image frame is also relatively long.

In an embodiment, the graphics processor may acquire the live streaming image frame and perform the special effect rendering operation, and the central server may perform the key point information identification operation. Therefore, after the live streaming image frame is acquired by the graphics processor, the live streaming image frame needs to be sent to the central processor for key point detection. To improve the special effect rendering speed, an amount of data to be transmitted may be reduced during a data transmission process. Specifically, the graphics processor may perform the first scaling operation on the live streaming image frame to obtain the live streaming image frame of the first preset resolution, and send the live streaming image frame of the first preset resolution to the central processor. In actual application, a corresponding first preset resolution may be set according to an actual requirement, which is not limited in the present disclosure. For example, an 8K live streaming image frame may be scaled to a 1K live streaming image frame.

After the live streaming image frame of the first preset resolution is acquired by the central processor, since content definition in the live streaming image frame of the first preset resolution is lower than content definition in the original live streaming image frame, the central processor may perform coarse-grained prediction on an region where the target objects in the live streaming image frame of the first preset resolution are located, to obtain a prediction region corresponding to at least part of the target objects in the live streaming image frame of the first preset resolution. The central processor then sends the prediction region corresponding to the at least part of the target objects in the live streaming image frame of the first preset resolution to the graphics processor.

After the prediction region corresponding to the at least part of the target objects is obtained by the graphics processor, the special effect rendering operation may be directly performed on the prediction region to obtain the target image frame. In an embodiment, to further improve special effect rendering precision, the graphics processor may further perform the cropping operation on the target objects according to the prediction region corresponding to the at least part of the target objects to obtain the original pixel image corresponding to the at least part of the prediction region. The original pixel image has the same pixels as the live streaming image frame. Since a size of the original pixel image is much smaller than a size of the live streaming image frame, a transmission speed is higher when the original pixel image is transmitted to the central processor.

Correspondingly, after the original pixel image corresponding to the at least part of the prediction region is acquired by the central processor, the central processor may perform an identification operation for key point information of the target objects in the original pixel image to obtain key point information of the at least part of the target objects, and feed back the key point information to the graphics processor. When a target object is a person, the key point information may be coordinate information of a key position such as a head and facial features of the person.

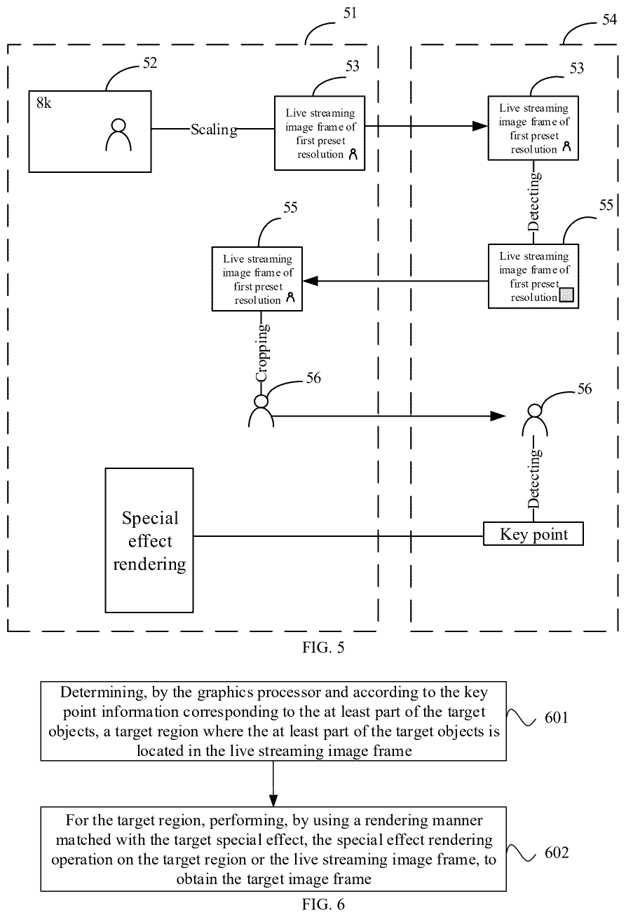

FIG. 5 is a diagram of an application scenario provided by an embodiment of the present disclosure. As shown in FIG. 5, a graphics processor 51 may perform a first scaling operation on a live streaming image frame 52 to obtain a live streaming image frame 53 of a first preset resolution, and transmit the live streaming image frame 53 of the first preset resolution to a central processor 54. The central processor 54 may perform detection for a prediction region of the live streaming image frame 53 of the first preset resolution to obtain a prediction region 55 corresponding to at least part of target objects in the live streaming image frame. The central processor 54 sends the prediction region 55 corresponding to the at least part of the target objects in the live streaming image frame to the graphics processor 51, so that the graphics processor 51 can perform a cropping operation on the prediction region 55 corresponding to the at least part of the target objects in the live streaming image frame, and send an original pixel image 56 corresponding to at least part of a cropped prediction region to the central processor 54. The central processor 54 can detect a key point in the original pixel image 56 corresponding to the at least part of the prediction region, and feed back the key point to the graphics processor 51, so that the graphics processor 51 performs a special effect rendering operation on the live streaming image frame according to the key point information to obtain a target image frame.

Further, on the basis of any one of the foregoing embodiments, step 404 includes:
performing, by the graphics processor, a second scaling operation on the original pixel image corresponding to the at least part of the prediction region to obtain an original pixel image of a second preset resolution corresponding to the at least part of the prediction region; and
sending the original pixel image of the second preset resolution corresponding to the at least part of the prediction region to the central processor.

In the present embodiment, to further improve an image transmission speed, before the original pixel image is transmitted, the second scaling operation may be performed on the original pixel image to obtain the original pixel image of the second preset resolution corresponding to the at least part of the prediction region. A scaling scale of the second scaling operation is less than a scaling scale of the first scaling operation, that is, the second preset resolution is greater than the first preset resolution. The original pixel image of the second preset resolution corresponding to the at least part of the prediction region is sent to the central processor.

In the live streaming special effect rendering method provided in the present embodiment, during a data transmission process, the scaled live streaming image frame of the first preset resolution is sent to the central processor, and the original pixel image corresponding to the at least part of the cropped prediction region is sent to the central processor, so that an amount of data to be transmitted can be effectively reduced, and a data transmission speed between the graphics processor and the central processor is improved. Therefore, a speed of special effect rendering in a VR live streaming scenario can be improved.

Further, on the basis of any one of the foregoing embodiments, step 402 includes:
performing, by using the first preset detection algorithm, a detection operation for the target objects in the live streaming image frame of the first preset resolution, to determine first regions where at least part of the target objects is located;
determining, for at least two first regions that meet a preset combination condition, whether a size of a combined region obtained after the at least two first regions are combined is greater than a size of the at least two first regions when the at least two first regions are not combined;
if yes, determining the first regions as the prediction region;
if not, determining the combined region as the prediction region.

In the present embodiment, during a generation process of the prediction region, to reduce a calculation amount of subsequent special effect rendering, a combination operation may be performed on regions that meet the preset combination condition. Specifically, the target objects in the live streaming image frame of the first preset resolution may be detected by using the first preset detection algorithm to determine the first regions where the at least part of the target objects is located.

Whether at least part of the first regions meet the preset combination condition is determined. The preset combination condition includes but is not limited to that a distance between at least two first regions is less than a preset distance threshold, the at least two first regions have an intersection, or a coverage area of any first region is larger, and a coverage area of a first region around the first region with a larger coverage area is smaller, etc.

For the at least two first regions that meet the preset combination condition, it is determined whether the size of the combined region obtained after the at least two first regions are combined is greater than the size of the at least two first regions when the at least two first regions are not combined. If yes, the first regions are determined as the prediction region. If no, the combined region is determined as the prediction region.

In the live streaming special effect rendering method provided in the present embodiment, the graphics processor is used to perform the special effect rendering operation, and the central processor is used to perform the identification and detection operations. To further improve the special effect rendering speed, the range of the special effect rendering may be concentrated at the streamer or around the streamer, so that the pixel region that actually needs to be processed can be narrowed, and the efficiency of the special effect processing can be improved.

FIG. 6 is a flow diagram of a live streaming special effect rendering method provided by yet another embodiment of the present disclosure. On the basis of any one of the foregoing embodiments, the key point information includes coordinate information of a plurality of key points corresponding to the target objects. As shown in FIG. 6, step 203 includes following steps.

Step 601: determining, by the graphics processor and according to the key point information corresponding to the at least part of the target objects, a target region where the at least part of the target objects is located in the live streaming image frame.

Step 602: for the target region, performing, by using a rendering manner matched with the target special effect, the special effect rendering operation on the target region or the live streaming image frame, to obtain the target image frame.

In the present embodiment, to improve a speed of special effect rendering of the live streaming image frame and ensure a live streaming effect, a region where the special effect processing is performed can be concentrated at a position associated with the key point information.

Therefore, after the key point information corresponding to the at least part of the target objects is acquired, the graphics processor may determine, according to the key point information corresponding to the at least part of the target objects, the target region where the at least part of the target objects is located in the live streaming image frame. For each target region, a special effect rendering operation may be performed on the target region or the live streaming image frame by using a rendering manner corresponding to the target special effect preset by the user, to obtain the target image frame.

In the live streaming special effect rendering method provided in the present embodiment, the rendering region is concentrated around the target region, so that efficiency of special effect rendering can be improved.

Further, on the basis of any one of the foregoing embodiments, before step 201, the method further includes:
acquiring, by the graphics processor, an original image frame corresponding to the virtual reality live streaming content collected by the binocular image collection apparatus, and performing a hardware decoding operation and a format conversion operation on the original image frame to obtain the live streaming image frame.

In the present embodiment, to further improve the speed of the special effect rendering and avoid excessive information exchange between the graphics processor and the central processor, preprocessing of the original image frame may be performed by the graphics processor.

Correspondingly, the live streaming special effect rendering apparatus may acquire the original image frame corresponding to the virtual reality live streaming content collected by the binocular image collection apparatus, and perform the hardware decoding operation and the format conversion operation on the original image frame to obtain the live streaming image frame.

In the live streaming special effect rendering method provided in the present embodiment, the preprocessing of the original image frame is performed by the graphics processor, so that a time delay caused by excessive transmission of the live streaming image frame can be effectively avoided, and a rendering speed of the live streaming image frame is improved.

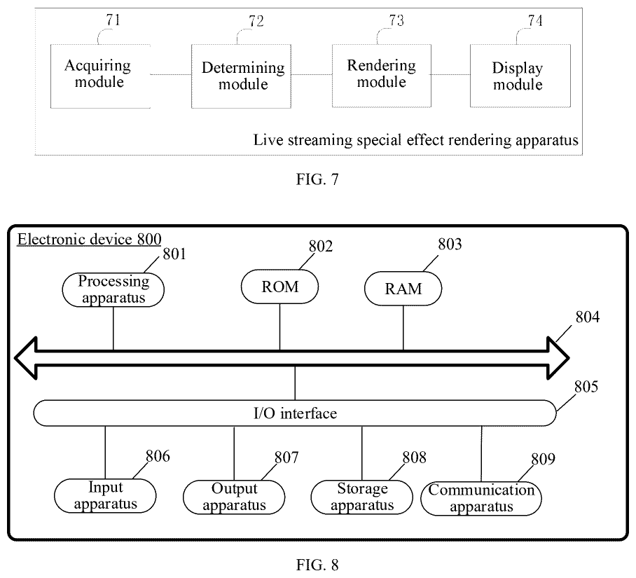

FIG. 7 is a structural diagram of a live streaming special effect rendering apparatus provided by an embodiment of the present disclosure, which is applied to a graphics processor. As shown in FIG. 7, the apparatus includes: an acquiring module 71, a determining module 72, a rendering module 73, and a display module 74. The acquiring module 71 is configured to acquire a live streaming image frame corresponding to virtual reality live streaming content and a preset target special effect. The determining module 72 is configured to determine key point information corresponding to at least part of target objects in the live streaming image frame. The rendering module 73 is configured to perform, according to the target special effect and the key point information, a special effect rendering operation on the live streaming image frame to obtain a target image frame. The display module 74 is configured to display the target image frame.

Further, on the basis of any one of the foregoing embodiments, the rendering module is configured to: determine, according to the key point information corresponding to the at least part of the target objects, a target region where the at least part of the target objects is located in the live streaming image frame; if the target special effect is a special effect applied to a local region, for at least part of the target region, perform, according to the target special effect, a local rendering operation on the target region, to obtain a rendering result of the target region; and for the at least part of the target region, cover the live streaming image frame with the rendering result of the target region to obtain the target image frame.

Further, on the basis of any one of the foregoing embodiments, the rendering module is configured to: if it is detected that the target special effect meets a preset expansion condition, perform, based on a preset region expansion algorithm, an expansion operation on the target region, to obtain a region to be rendered; and perform, according to the target special effect, a local rendering operation on the region to be rendered.

Further, on the basis of any one of the foregoing embodiments, the rendering module is configured to: if the target special effect is a special effect applied to a global region, perform, according to the target special effect, the special effect rendering operation on the live streaming image frame, to obtain the target image frame.

Further, on the basis of any one of the foregoing embodiments, the determining module is configured to: determine, by a preset central processor, the key point information corresponding to the at least part of the target objects in the live streaming image frame. The rendering module is configured to: perform, by a preset graphics processor, the special effect rendering operation on the live streaming image frame according to the target special effect and the key point information to obtain the target image frame.

Further, on the basis of any one of the foregoing embodiments, the determining module is configured to: perform a size adjustment operation on the live streaming image frame to obtain an adjusted live streaming image frame; and determine, by the central processor, the key point information corresponding to the at least part of the target objects in the adjusted live streaming image frame.

Further, on the basis of any one of the foregoing embodiments, the determining module is configured to: perform, by the graphics processor, a first scaling operation on the live streaming image frame to obtain a live streaming image frame of a first preset resolution, and send the live streaming image frame of the first preset resolution to the central processor; detect, by the central processor and according to a first preset detection algorithm, a prediction region corresponding to the at least part of the target objects in the live streaming image frame of the first preset resolution, and send the prediction region corresponding to the at least part of the target objects to the graphics processor; perform, by the graphics processor and according to the prediction region, a cropping operation on the at least part of the target objects in the live streaming image frame, to obtain an original pixel image corresponding to at least part of the prediction region, and send the original pixel image corresponding to the at least part of the prediction region to the central processor; and determine, by the central processor and according to a second preset detection algorithm, key points corresponding to the target objects in the at least part of the prediction region.

Further, on the basis of any one of the foregoing embodiments, the determining module is configured to: perform, by the graphics processor, a second scaling operation on the original pixel image corresponding to the at least part of the prediction region, to obtain an original pixel image of a second preset resolution corresponding to the at least part of the prediction region; and send the original pixel image of the second preset resolution corresponding to the at least part of the prediction region to the central processor.

Further, on the basis of any one of the foregoing embodiments, the key point information includes coordinate information of a plurality of key points corresponding to the target objects. The rendering module is configured to: determine, by the graphics processor and according to the key point information corresponding to the at least part of the target objects, a target region where the at least part of the target objects is located in the live streaming image frame; and for the target region, perform, by using a rendering manner matched with the target special effect, a special effect rendering operation on the target region or the live streaming image frame, to obtain the target image frame.

Further, on the basis of any one of the foregoing embodiments, the apparatus further includes: a preprocessing module, configured to: acquiring, by the graphics processor, an original image frame corresponding to the virtual reality live streaming content collected by a binocular image collection apparatus, and perform a hardware decoding operation and a format conversion operation on the original image frame to obtain the live streaming image frame.

Further, on the basis of any one of the foregoing embodiments, the rendering module is configured to: perform, by using the first preset detection algorithm, a detection operation for the target objects in the live streaming image frame of the first preset resolution, to determine first regions where at least part of the target objects is located; determine, for at least two first regions that meet a preset combination condition, whether a size of a combined region obtained after the at least two first regions are combined is greater than a size of the at least two first regions when the at least two first regions are not combined; if yes, determine the first regions as the prediction region; if not, determine the combined region as the prediction region.

The device provided in the present embodiment can be used to perform the technical solutions of the method embodiments described above, and implementation principles and technical effects thereof are similar, which are not repeated in the present embodiment.

To implement the foregoing embodiments, an embodiment of the present disclosure further provides an electronic device, including: a processor and a memory.

The memory stores a computer-executable instruction.

The processor executes the computer-executable instruction stored in the memory, to cause the processor to execute the live streaming special effect rendering method according to any one of the foregoing embodiments.

FIG. 8 is a structural diagram of an electronic device provided by an embodiment of the present disclosure. As shown in FIG. 8, the electronic device 800 may be a terminal device or a server. The terminal device may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (for example, a vehicle navigation terminal), and fixed terminals such as a digital TV and a desktop computer. The electronic device shown in FIG. 8 is merely an example, and shall not impose any limitation on functions and scope of use of the embodiments of the present disclosure.

As shown in FIG. 8, the electronic device 800 may include a processing apparatus (for example, a central processor, a graphics processor, or the like) 801 that may execute a variety of appropriate actions and processing according to a program stored in a read only memory (ROM) 802 or a program loaded from a storage apparatus 808 into a random access memory (RAM) 803. The RAM 803 further stores various programs and data required for operations of the electronic device 800. The processing apparatus 801, the ROM 802, and the RAM 803 are connected to each other via a bus 804. An input/output (I/O) interface 805 is also connected to the bus 804.

Generally, following apparatuses may be connected to the I/O interface 805: an input apparatus 806 including, for example, a touch screen, a touchpad, a keyboard, a mouse, a camera, a microphone, an accelerometer, and a gyroscope, etc.; an output apparatus 807 including, for example, a liquid crystal display (LCD), a speaker, and a vibrator, etc.; the storage apparatus 808 including, for example, a tape and a hard disk, etc.; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the shown apparatuses. It may be an alternative to implement or have more or fewer apparatuses.

In particular, according to an embodiment of the present disclosure, the processes described above with reference to the flow diagrams may be implemented as a computer software program. For example, an embodiment of the present disclosure includes a computer program product, which includes a computer program carried on a computer-readable medium, where the computer program includes program code for executing the methods shown in the flow diagrams. In such an embodiment, the computer program may be downloaded and installed from a network through the communication apparatus 809, or installed from the storage apparatus 808, or installed from the ROM 802. When the computer program is executed by the processing apparatus 801, the above-mentioned functions defined in the methods of the embodiments of the present disclosure are executed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a RAM, a ROM, an erasable programmable read only memory (EPROM) or a flash memory, an optical fiber, a portable compact disk read only memory (CD-ROM), an optical storage device, a magnetic storage device, or any suitable combination thereof. In the present disclosure, the computer-readable storage medium may be any tangible medium containing or storing a program that may be used by or in combination with an instruction execution system, an apparatus, or a device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, an apparatus, or a device. The program code contained in the computer-readable medium may be transmitted by any suitable medium, including but not limited to electric wires, optical cables, radio frequency (RF), and the like, or any suitable combination thereof.

An embodiment of the present disclosure further provides a computer-readable storage medium, where the computer-readable storage medium stores a computer-executable instruction, and when a processor executes the computer-executable instruction, the live streaming special effect rendering method according to any of the foregoing embodiments is implemented.

An embodiment of the present disclosure further provides a computer program product, including a computer program that, when executed by a processor, implements the live streaming special effect rendering method according to any one of the foregoing embodiments.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to execute the methods shown in the foregoing embodiments.

Computer program codes for executing operations in the present disclosure may be written in one or more programming languages or a combination thereof, where the programming languages include an object-oriented programming language, such as Java, Smalltalk, and C++, and further include conventional procedural programming languages, such as “C” language or similar programming languages. The program codes may be completely executed on a computer of a user, partially executed on a computer of a user, executed as an independent software package, partially executed on a computer of a user and partially executed on a remote computer, or completely executed on a remote computer or server. In a case involving a remote computer, the remote computer may be connected to a computer of a user over any type of network, including a local area network (LAN) or a wide area network (WAN), or may be connected to an external computer (for example, connected over the Internet using an Internet service provider).

The flow diagrams and block diagrams in the drawings illustrate possibly implemented architectures, functions, and operations of the system, the method, and the computer program product according to various embodiments of the present disclosure. In this regard, each block in the flow diagrams or block diagrams may represent a module, a program segment, or a part of codes, and the module, the program segment, or the part of codes contains one or more executable instructions for implementing specified logical functions. It should also be noted that, in some alternative implementations, functions marked in the blocks may also occur in an order different from that marked in the drawings. For example, two blocks shown in succession can actually be executed substantially in parallel, or may sometimes be executed in a reverse order, depending on a function involved. It should also be noted that each block in the block diagrams and/or the flow diagrams, and a combination of blocks in the block diagrams and/or the flow diagrams may be implemented by a dedicated hardware-based system that executes specified functions or operations, or may be implemented by a combination of dedicated hardware and computer instructions.

Related units described in the embodiments of the present disclosure may be implemented by means of software, or may be implemented by means of hardware. A name of a unit does not constitute a limitation on the unit in some cases, for example, a first acquiring unit may also be described as “a unit for acquiring at least two Internet protocol addresses”.

The functions described herein above may be executed at least partially by one or more hardware logic components. For example, without limitation, exemplary types of hardware logic components that may be used include: a field programmable gate array (FPGA), an application specific integrated circuit (ASIC), application specific standard parts (ASSP), a system on chip (SOC), a complex programmable logic device (CPLD), and the like.

In the context of the present disclosure, a machine-readable medium may be a tangible medium that may contain or store a program used by or in combination with an instruction execution system, an apparatus, or a device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a RAM, a ROM, an EPROM or a flash memory, an optic fiber, a CD-ROM, an optical storage device, a magnetic storage device, or any suitable combination thereof.

In a first aspect, according to one or more embodiments of the present disclosure, a live streaming special effect rendering method is provided, including:
acquiring a live streaming image frame corresponding to virtual reality live streaming content and a preset target special effect;
determining key point information corresponding to at least part of target objects in the live streaming image frame;
performing, according to the target special effect and the key point information, a special effect rendering operation on the live streaming image frame, to obtain a target image frame; and
displaying the target image frame.

According to one or more embodiments of the present disclosure, the performing, according to the target special effect and the key point information, a special effect rendering operation on the live streaming image frame, to obtain a target image frame includes:
determining, according to the key point information corresponding to the at least part of the target objects, a target region where the at least part of the target objects is located in the live streaming image frame;
if the target special effect is a special effect applied to a local region, for at least part of the target region, performing, according to the target special effect, a local rendering operation on the target region, to obtain a rendering result of the target region; and
for the at least part of the target region, covering the live streaming image frame with the rendering result of the target region, to obtain the target image frame.

According to one or more embodiments of the present disclosure, the performing, according to the target special effect, a local rendering operation on the target region includes:
if it is detected that the target special effect meets a preset expansion condition, performing, based on a preset region expansion algorithm, an expansion operation on the target region, to obtain a region to be rendered; and
performing, according to the target special effect, the local rendering operation on the region to be rendered.

According to one or more embodiments of the present disclosure, the performing, according to the target special effect and the key point information, a special effect rendering operation on the live streaming image frame, to obtain a target image frame includes:
if the target special effect is a special effect applied to a global region, performing, according to the target special effect, the special effect rendering operation on the live streaming image frame, to obtain the target image frame.

According to one or more embodiments of the present disclosure, the determining key point information corresponding to at least part of target objects in the live streaming image frame includes:
determining, by a preset central processor, the key point information corresponding to the at least part of the target objects in the live streaming image frame; and
the performing, according to the target special effect and the key point information, a special effect rendering operation on the live streaming image frame, to obtain a target image frame includes:
performing, by a preset graphics processor, the special effect rendering operation on the live streaming image frame according to the target special effect and the key point information to obtain the target image frame.

According to one or more embodiments of the present disclosure, the determining key point information corresponding to at least part of target objects in the live streaming image frame includes:
performing a size adjustment operation on the live streaming image frame to obtain an adjusted live streaming image frame; and
determining, by the central processor, the key point information corresponding to the at least part of the target objects in the adjusted live streaming image frame.

According to one or more embodiments of the present disclosure, the determining key point information corresponding to at least part of target objects in the live streaming image frame includes:
performing, by the graphics processor, a first scaling operation on the live streaming image frame to obtain a live streaming image frame of a first preset resolution, and sending the live streaming image frame of the first preset resolution to the central processor;
detecting, by the central processor and according to a first preset detection algorithm, a prediction region corresponding to the at least part of the target objects in the live streaming image frame of the first preset resolution, and sending the prediction region corresponding to the at least part of the target objects to the graphics processor;
performing, by the graphics processor and according to the prediction region, a cropping operation on the at least part of the target objects in the live streaming image frame to obtain an original pixel image corresponding to at least part of the prediction region, and sending the original pixel image corresponding to the at least part of the prediction region to the central processor; and
determining, by the central processor and according to a second preset detection algorithm, key points corresponding to the target objects in the at least part of the prediction region.

According to one or more embodiments of the present disclosure, the sending the original pixel image corresponding to the at least part of the prediction region to the central processor includes:
performing, by the graphics processor, a second scaling operation on the original pixel image corresponding to the at least part of the prediction region to obtain an original pixel image of a second preset resolution corresponding to the at least part of the prediction region; and
sending the original pixel image of the second preset resolution corresponding to the at least part of the prediction region to the central processor.

According to one or more embodiments of the present disclosure, the key point information includes coordinate information of a plurality of key points corresponding to the target objects; and the performing, according to the target special effect and the key point information, a special effect rendering operation on the live streaming image frame, to obtain a target image frame includes:
determining, by the graphics processor and according to the key point information corresponding to the at least part of the target objects, a target region where the at least part of the target objects is located in the live streaming image frame; and
for the target region, performing, by using a rendering manner matched with the target special effect, the special effect rendering operation on the target region or the live streaming image frame, to obtain the target image frame.

According to one or more embodiments of the present disclosure, before the acquiring a live streaming image frame corresponding to virtual reality live streaming content and a preset target special effect, the method further includes:
acquiring, by the graphics processor, an original image frame corresponding to the virtual reality live streaming content collected by a binocular image collection apparatus, and performing a hardware decoding operation and a format conversion operation on the original image frame to obtain the live streaming image frame.

According to one or more embodiments of the present disclosure, the detecting, by the central processor and according to a first preset detection algorithm, a prediction region corresponding to the at least part of the target objects in the live streaming image frame of the first preset resolution includes:
performing, by using the first preset detection algorithm, a detection operation for the target objects in the live streaming image frame of the first preset resolution, to determine first regions where at least part of the target objects is located;
determining, for at least two first regions that meet a preset combination condition, whether a size of a combined region obtained after the at least two first regions are combined is greater than a size of the at least two first regions when the at least two first regions are not combined;
if yes, determining the first regions as the prediction region;
if not, determining the combined region as the prediction region.

In a second aspect, according to one or more embodiments of the present disclosure, a live streaming special effect rendering apparatus is provided, including:
an acquiring module, configured to acquire a live streaming image frame corresponding to virtual reality live streaming content and a preset target special effect;
a determining module, configured to determine key point information corresponding to at least part of target objects in the live streaming image frame;
a rendering module, configured to perform, according to the target special effect and the key point information, a special effect rendering operation on the live streaming image frame, to obtain a target image frame; and
a display module, configured to display the target image frame.

According to one or more embodiments of the present disclosure, the rendering module is configured to:
determine, according to the key point information corresponding to the at least part of the target objects, a target region where the at least part of the target objects is located in the live streaming image frame;
if the target special effect is a special effect applied to a local region, for at least part of the target region, perform, according to the target special effect, a local rendering operation on the target region, to obtain a rendering result of the target region; and
for the at least part of the target region, cover the live streaming image frame with the rendering result of the target region to obtain the target image frame.

According to one or more embodiments of the present disclosure, the rendering module is configured to:
if it is detected that the target special effect meets a preset expansion condition, perform, based on a preset region expansion algorithm, an expansion operation on the target region, to obtain a region to be rendered; and
perform, according to the target special effect, a local rendering operation on the region to be rendered.

According to one or more embodiments of the present disclosure, the rendering module is configured to:
if the target special effect is a special effect applied to a global region, perform, according to the target special effect, the special effect rendering operation on the live streaming image frame, to obtain the target image frame.

According to one or more embodiments of the present disclosure, the determining module is configured to:
determine, by a preset central processor, the key point information corresponding to the at least part of the target objects in the live streaming image frame; and
the rendering module is configured to:
perform, by a preset graphics processor, the special effect rendering operation on the live streaming image frame according to the target special effect and the key point information to obtain the target image frame.

According to one or more embodiments of the present disclosure, the determining module is configured to:
perform a size adjustment operation on the live streaming image frame to obtain an adjusted live streaming image frame; and
determine, by the central processor, the key point information corresponding to the at least part of the target objects in the adjusted live streaming image frame.

According to one or more embodiments of the present disclosure, the determining module is configured to:
perform, by the graphics processor, a first scaling operation on the live streaming image frame to obtain a live streaming image frame of a first preset resolution, and send the live streaming image frame of the first preset resolution to the central processor;
detect, by the central processor and according to a first preset detection algorithm, a prediction region corresponding to the at least part of the target objects in the live streaming image frame of the first preset resolution, and send the prediction region corresponding to the at least part of the target objects to the graphics processor;
perform, by the graphics processor and according to the prediction region, a cropping operation on the at least part of the target objects in the live streaming image frame, to obtain an original pixel image corresponding to at least part of the prediction region, and send the original pixel image corresponding to the at least part of the prediction region to the central processor; and
determine, by the central processor and according to a second preset detection algorithm, key points corresponding to the target objects in the at least part of the prediction region.

According to one or more embodiments of the present disclosure, the determining module is configured to:
perform, by the graphics processor, a second scaling operation on the original pixel image corresponding to the at least part of the prediction region, to obtain an original pixel image of a second preset resolution corresponding to the at least part of the prediction region; and
send the original pixel image of the second preset resolution corresponding to the at least part of the prediction region to the central processor.

According to one or more embodiments of the present disclosure, the key point information includes coordinate information of a plurality of key points corresponding to the target objects; and the rendering module is configured to:
determine, by the graphics processor and according to the key point information corresponding to the at least part of the target objects, a target region where the at least part of the target objects is located in the live streaming image frame; and
for the target region, perform, by using a rendering manner matched with the target special effect, a special effect rendering operation on the target region or the live streaming image frame, to obtain the target image frame.

According to one or more embodiments of the present disclosure, the apparatus further includes: a preprocessing module, configured to:
acquiring, by the graphics processor, an original image frame corresponding to the virtual reality live streaming content collected by a binocular image collection apparatus, and perform a hardware decoding operation and a format conversion operation on the original image frame to obtain the live streaming image frame.

According to one or more embodiments of the present disclosure, the rendering module is configured to:
perform, by using the first preset detection algorithm, a detection operation for the target objects in the live streaming image frame of the first preset resolution, to determine first regions where at least part of the target objects is located;
determine, for at least two first regions that meet a preset combination condition, whether a size of a combined region obtained after the at least two first regions are combined is greater than a size of the at least two first regions when the at least two first regions are not combined;
if yes, determine the first regions as the prediction region;
if not, determine the combined region as the prediction region.

In a third aspect, according to one or more embodiments of the present disclosure, an electronic device is provided, including: at least one processor and a memory;
the memory stores a computer-executable instruction; and
the at least one processor executes the computer-executable instruction stored in the memory, to cause the at least one processor to execute the live streaming special effect rendering method according to the first aspect and the various possible designs of the first aspect.

In a fourth aspect, according to one or more embodiments of the present disclosure, a computer-readable storage medium is provided, where the computer-readable storage medium stores a computer-executable instruction, and when a processor executes the computer-executable instruction, the live streaming special effect rendering method according to the first aspect and the various possible designs of the first aspect is implemented.

In a fifth aspect, according to one or more embodiments of the present disclosure, a computer program product is provided, including a computer program that, when executed by a processor, implements the live streaming special effect rendering method according to the first aspect and the various possible designs of the first aspect.

In a sixth aspect, according to one or more embodiments of the present disclosure, a computer program is provided, where the computer program, when executed by a processor, implements the live streaming special effect rendering method according to the first aspect and the various possible designs of the first aspect.

In the live streaming special effect rendering method, the apparatus, the electronic device, the computer-readable storage medium, the computer program product, and the computer program provided in these embodiments, after a live streaming image frame corresponding to virtual reality live streaming content is acquired, key point information in the live streaming image frame is determined, and a special effect rendering operation is performed on a position associated with the key point information in the live streaming image frame according to the key point information, so that a region where special effect processing is performed can be concentrated at the position associated with the key point information, and a region where the special effect processing needs to be performed is effectively narrowed. Therefore, efficiency of the special effect processing can be improved.

The foregoing descriptions are merely preferred embodiments of the present disclosure and explanations of the applied technical principles. Persons skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure, for example, the technical solution formed by replacing the foregoing features with technical features with similar functions disclosed in the present disclosure (but not limited thereto).

In addition, although the various operations are depicted in a specific order, it should not be understood as requiring these operations to be executed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in a single embodiment may also be implemented in a plurality of embodiments individually or in any suitable subcombination.

Although the subject matter has been described in a language specific to structural features and/or logical actions of methods, it should be understood that the subject matter defined in the appended claims is not necessarily limited to the specific features or actions described above. In contrast, the specific features and actions described above are merely exemplary forms of implementing the claims.

1. A live streaming special effect rendering method, comprising:
acquiring a live streaming image frame corresponding to virtual reality live streaming content and a preset target special effect;
determining key point information corresponding to at least part of target objects in the live streaming image frame;
performing, according to the target special effect and the key point information, a special effect rendering operation on the live streaming image frame, to obtain a target image frame; and
displaying the target image frame.

2. The method according to claim 1, wherein the performing, according to the target special effect and the key point information, a special effect rendering operation on the live streaming image frame, to obtain a target image frame comprises:
determining, according to the key point information corresponding to the at least part of the target objects, a target region where the at least part of the target objects is located in the live streaming image frame;
if the target special effect is a special effect applied to a local region, for at least part of the target region, performing, according to the target special effect, a local rendering operation on the target region, to obtain a rendering result of the target region; and
for the at least part of the target region, covering the live streaming image frame with the rendering result of the target region, to obtain the target image frame.

3. The method according to claim 2, wherein the performing, according to the target special effect, a local rendering operation on the target region comprises:
if it is detected that the target special effect meets a preset expansion condition, performing, based on a preset region expansion algorithm, an expansion operation on the target region, to obtain a region to be rendered; and
performing, according to the target special effect, the local rendering operation on the region to be rendered.

4. The method according to claim 1, wherein the performing, according to the target special effect and the key point information, a special effect rendering operation on the live streaming image frame, to obtain a target image frame comprises:
if the target special effect is a special effect applied to a global region, performing, according to the target special effect, the special effect rendering operation on the live streaming image frame, to obtain the target image frame.

5. The method according to claim 1, wherein the determining key point information corresponding to at least part of target objects in the live streaming image frame comprises:
determining, by a preset central processor, the key point information corresponding to the at least part of the target objects in the live streaming image frame; and
the performing, according to the target special effect and the key point information, a special effect rendering operation on the live streaming image frame, to obtain a target image frame comprises:
performing, by a preset graphics processor, the special effect rendering operation on the live streaming image frame according to the target special effect and the key point information to obtain the target image frame.

6. The method according to claim 1, wherein the determining key point information corresponding to at least part of target objects in the live streaming image frame comprises:
performing a size adjustment operation on the live streaming image frame to obtain an adjusted live streaming image frame; and
determining, by a central processor, the key point information corresponding to the at least part of the target objects in the adjusted live streaming image frame.

7. The method according to claim 1, wherein the determining key point information corresponding to at least part of target objects in the live streaming image frame comprises:
performing, by a graphics processor, a first scaling operation on the live streaming image frame to obtain a live streaming image frame of a first preset resolution, and sending the live streaming image frame of the first preset resolution to a central processor;
detecting, by the central processor and according to a first preset detection algorithm, a prediction region corresponding to the at least part of the target objects in the live streaming image frame of the first preset resolution, and sending the prediction region corresponding to the at least part of the target objects to the graphics processor;
performing, by the graphics processor and according to the prediction region, a cropping operation on the at least part of the target objects in the live streaming image frame to obtain an original pixel image corresponding to at least part of the prediction region, and sending the original pixel image corresponding to the at least part of the prediction region to the central processor; and
determining, by the central processor and according to a second preset detection algorithm, key points corresponding to the target objects in the at least part of the prediction region.

8. The method according to claim 7, wherein the sending the original pixel image corresponding to the at least part of the prediction region to the central processor comprises:
performing, by the graphics processor, a second scaling operation on the original pixel image corresponding to the at least part of the prediction region to obtain an original pixel image of a second preset resolution corresponding to the at least part of the prediction region; and
sending the original pixel image of the second preset resolution corresponding to the at least part of the prediction region to the central processor.

9. The method according to claim 1, wherein the key point information comprises coordinate information of a plurality of key points corresponding to the target objects; and the performing, according to the target special effect and the key point information, a special effect rendering operation on the live streaming image frame, to obtain a target image frame comprises:
determining, by a graphics processor and according to the key point information corresponding to the at least part of the target objects, a target region where the at least part of the target objects is located in the live streaming image frame; and
for the target region, performing, by using a rendering manner matched with the target special effect, the special effect rendering operation on the target region or the live streaming image frame, to obtain the target image frame.

10. The method according to claims 1, wherein before the acquiring a live streaming image frame corresponding to virtual reality live streaming content and a preset target special effect, the method further comprises:
acquiring, by a graphics processor, an original image frame corresponding to the virtual reality live streaming content collected by a binocular image collection apparatus, and performing a hardware decoding operation and a format conversion operation on the original image frame to obtain the live streaming image frame.

11. The method according to claim wherein the detecting, by the central processor and according to a first preset detection algorithm, a prediction region corresponding to the at least part of the target objects in the live streaming image frame of the first preset resolution comprises:
performing, by using the first preset detection algorithm, a detection operation for the target objects in the live streaming image frame of the first preset resolution, to determine first regions where at least part of the target objects is located;
determining, for at least two first regions that meet a preset combination condition, whether a size of a combined region obtained after the at least two first regions are combined is greater than a size of the at least two first regions when the at least two first regions are not combined;
if yes, determining the first regions as the prediction region;
if not, determining the combined region as the prediction region.

12. A live streaming special effect rendering apparatus, comprising:
a processor and a memory; wherein the memory stores a computer-executable instruction; and
the processor executes the computer-executable instruction stored in the memory, to enable the processor to:
acquire a live streaming image frame corresponding to virtual reality live streaming content and a preset target special effect;
determine key point information corresponding to at least part of target objects in the live streaming image frame;
perform, according to the target special effect and the key point information, a special effect rendering operation on the live streaming image frame, to obtain a target image frame; and
display the target image frame.

13. (canceled)

14. A non-transitory computer-readable storage medium, wherein the non-transitory computer-readable storage medium stores a computer-executable instruction which, when executed by a processor enables the processor to:
acquire a live streaming image frame corresponding to virtual reality live streaming content and a preset target special effect;
determine key point information corresponding to at least part of target objects in the live streaming image frame;
perform, according to the target special effect and the key point information, a special effect rendering operation on the live streaming image frame, to obtain a target image frame; and
display the target image frame.

15. (canceled)

16. (canceled)

17. The apparatus according to claim 12, wherein the processor is further enabled to:
determine, according to the key point information corresponding to the at least part of the target objects, a target region where the at least part of the target objects is located in the live streaming image frame;
if the target special effect is a special effect applied to a local region, for at least part of the target region, perform, according to the target special effect, a local rendering operation on the target region, to obtain a rendering result of the target region; and
for the at least part of the target region, cover the live streaming image frame with the rendering result of the target region to obtain the target image frame.

18. The apparatus according to claim 17, wherein the processor is further enabled to:
if it is detected that the target special effect meets a preset expansion condition, perform, based on a preset region expansion algorithm, an expansion operation on the target region, to obtain a region to be rendered; and
perform, according to the target special effect, a local rendering operation on the region to be rendered.

19. The apparatus according to claim 12, wherein the processor is further enabled to:
if the target special effect is a special effect applied to a global region, perform, according to the target special effect, the special effect rendering operation on the live streaming image frame, to obtain the target image frame.

20. The apparatus according to claim 12, wherein the processor is further enabled to:
determine the key point information corresponding to the at least part of the target objects in the live streaming image frame; and
perform the special effect rendering operation on the live streaming image frame according to the target special effect and the key point information to obtain the target image frame.

21. The apparatus according to claim 12, wherein the processor is further enabled to:
perform a size adjustment operation on the live streaming image frame to obtain an adjusted live streaming image frame; and
determine the key point information corresponding to the at least part of the target objects in the adjusted live streaming image frame.

22. The apparatus according to claim 12, wherein the processor is further enabled to:
perform a first scaling operation on the live streaming image frame to obtain a live streaming image frame of a first preset resolution;
detect, according to a first preset detection algorithm, a prediction region corresponding to the at least part of the target objects in the live streaming image frame of the first preset resolution;
perform, according to the prediction region, a cropping operation on the at least part of the target objects in the live streaming image frame, to obtain an original pixel image corresponding to at least part of the prediction region; and
determine, according to a second preset detection algorithm, key points corresponding to the target objects in the at least part of the prediction region.

23. The apparatus according to claim 22, wherein the processor is further enabled to: perform a second scaling operation on the original pixel image corresponding to the at least part of the prediction region, to obtain an original pixel image of a second preset resolution corresponding to the at least part of the prediction region.
